(19) United States
(12) Patent Application Publication
(10) Pub. No.: US 2009/0307733 A1
(43) Pub. Date: Dec. 10, 2009

(54) DOWNLOADING METHOD AND APPARATUS OF TERMINAL ENTITY

(75) Inventors: Hyung-tak CHOI, Suwon-si (KR); Soon-back Cha, Suwon-si (KR); Ho Jin, Yongin-si (KR); Sung-jin Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/477,294

(22) Filed: Jun. 3, 2009

Related U.S. Application Data
(60) Provisional application No. 61/058,605, filed on Jun. 4, 2008.

(30) Foreign Application Priority Data
May 25, 2009 (KR) 10-2009-0045470

(51) Int. Cl. H04N 7/173

(52) U.S. Cl. 725/98

(57) ABSTRACT

Provided are downloading methods and apparatuses related to a terminal entity presenting an event related to at least one download item related to an Internet protocol television (IPTV) service.

### CROSS-REFERENCE TO RELATED PATENT APPLICATION

This application claims the benefit of U.S. Provisional Patent Application No. 61/058,605, filed on Jun. 4, 2008, in the U.S. Patent and Trademark Office, and the benefit of Korean Patent Application No. 10-2009-0045470, filed on May 25, 2009, in the Korean Intellectual Property Office, the disclosures of which are incorporated herein in their entirety by reference.

### BACKGROUND OF THE INVENTION

1. Field of the Invention

The present invention relates to a downloading method and apparatus, and more particularly, to a downloading method and apparatus of a terminal entity using an Internet protocol television (IPTV) service.

2. Description of the Related Art

Internet protocol television (IPTV) services refer to services of providing information, moving picture content and broadcasting to televisions (TV) through Internet protocol (IP) networks, that is, through high speed Internet networks. IPTV services have received considerable attention while convergence services of communication and broadcasting are being accelerated. In this regard, activation of IPTV services will significantly affect content and consumer electronics fields in addition to communication and broadcasting fields.

The Open IPTV Forum has made a common standard that is not dependent upon an IPTV service provider, and has discussed providing an IPTV service to a consumer according to the common standard.

The Open IPTV Forum has set a goal that a user may easily use IPTV services of a plurality of IPTV service providers by making interface and hardware platforms that are not dependent upon the IPTV service providers. According to an open IPTV functional architecture, although a user does not have various set-top boxes that are dependent upon the respective IPTV service providers, since the user may use IPTV services of a plurality of different IPTV service providers, the scope of user's selection of IPTV services may be broadened.

In order for users to use services of a plurality of different IPTV service providers, a plurality of gateway entities relaying services of IPTV providers exist in a residential network of the open IPTV functional architecture. Examples of the entities include an application gateway (AG), an IP multimedia subsystem (IMS) gateway (IG), and a converged service platform (CSP) gateway (CG). From among these entities, the IG receives an event from the outside of a residential network, and then transmits the event to a terminal entity.

### SUMMARY OF THE INVENTION

The present invention provides a method and apparatus for downloading content related to Internet protocol television (IPTV) service, and a computer readable recording medium having recorded thereon a program for executing the method.

According to an aspect of the present invention, there is provided a downloading method of a terminal entity, the downloading method including receiving at least one download item from an Internet protocol television (IPTV) provider through a gateway entity relaying an IPTV service; and presenting an event related to the at least one download item through an application for using the IPTV service, wherein the gateway entity is an entity relaying IPTV services of a plurality of IPTV service providers to the terminal entity.

The presenting may include presenting only an event related to a download item related to one IPTV service provider from among the plurality of IPTV service providers.

The presenting may include presenting only an event related to a download item related to the one IPTV service provider by using a method of an application programming interface (API) of a browser, and the browser may provide an execution environment of the application.

The method of the API may include a method of adding or deleting a download item to or from a list of download items whose events are to be presented.

The presenting may include presenting only an event related to a download item related to the one IPTV service provider by using a call-back function.

The call-back function may include a call-back function which returns information regarding a download status.

The information regarding the download status may include at least one piece of information indicating that download is completed, information indicating that download is currently performed, information indicating that download is stopped, information indicating that download failure occurs, and information indicating that download is not started yet.

The presenting may include presenting only an event related to a download item related to a web page that is currently provided to a user through the application.

According to another aspect of the present invention, there is provided a downloading apparatus of a terminal entity, the downloading apparatus including a download managing unit receiving at least one download item from an Internet protocol television (IPTV) provider through a gateway entity relaying an IPTV service; and an application unit presenting an event related to the at least one download item through an application for using the IPTV service, wherein the gateway entity is an entity relaying IPTV services of a plurality of IPTV service providers to the terminal entity.

According to another aspect of the present invention, there is provided a computer readable recording medium having recorded thereon a program for executing the downloading method.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow chart for explaining a downloading method according to an exemplary embodiment of the present invention;

FIG. 2 is a diagram for explaining a method of presenting only an event related to some of download items, according to an exemplary embodiment of the present invention;

FIG. 3 is a diagram for explaining a method of presenting only an event related to some of download items, according to another exemplary embodiment of the present invention;

FIG. 4 is a diagram for explaining a downloading method according to another exemplary embodiment of the present invention;

FIG. 5 is a diagram for explaining a call-back function and a method, according to an exemplary embodiment of the present invention;

FIG. 6 is a flowchart for explaining a downloading method according to another exemplary embodiment of the present invention; and

FIG. 7 is a block diagram of a downloading apparatus according to an exemplary embodiment of the present invention.

### DETAILED DESCRIPTION OF THE INVENTION

Hereinafter, the present invention will be described in detail by explaining exemplary embodiments of the invention with reference to the attached drawings.

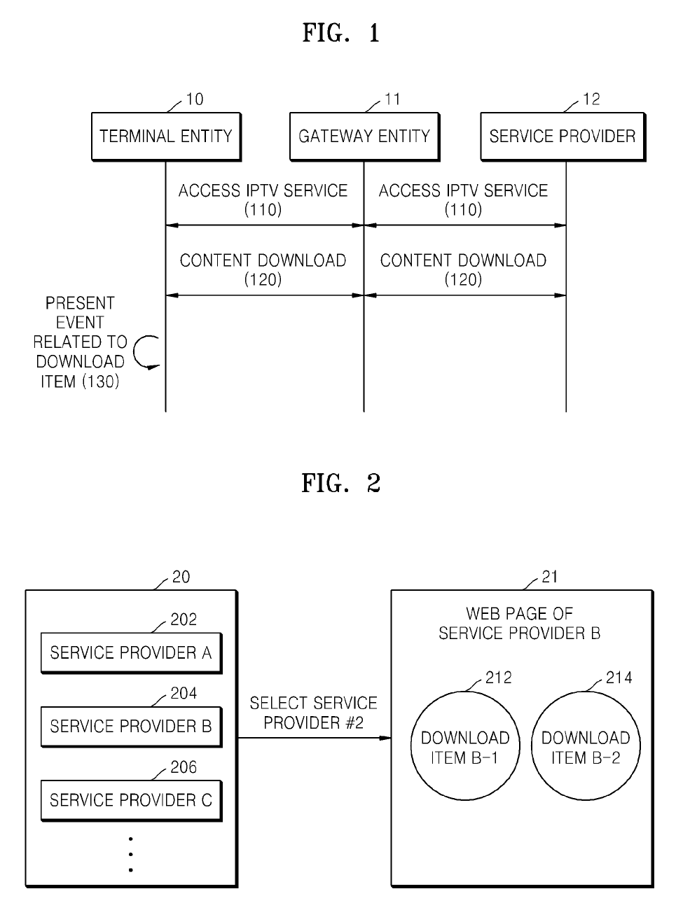

FIG. 1 is a flow chart for explaining a downloading method according to an exemplary embodiment of the present invention.

That is, FIG. 1 is a flow chart for explaining a method of downloading content related to an Internet protocol television (IPTV) service of a service provider 12, which is performed in a terminal entity 10, wherein the content is relayed by a gateway entity 11. Hereinafter, the case where the terminal entity 10 downloads content related to an IPTV service will be described.

The terminal entity 10 may be an open IPTV terminal function (OITF) entity according to an open IPTV forum functional architecture. The gateway entity 11 may be an IP multimedia subsystem (IMS) gateway (IG) entity. The service provider 12 may be a predetermined entity of a provider network including a plurality of IPTV service providers.

Referring to FIG. 1, in operation 110, the terminal entity 10 accesses the IPTV service through the gateway entity 11. That is, the terminal entity 10 accesses an IPTV service provider search entity (not shown) and searches for at least one IPTV service provider, and then accesses the IPTV service search entity and searches for the IPTV service of the at least one IPTV service provider.

The terminal entity 10 uses a predetermined IPTV service of a predetermined IPTV service provider, according to a result of searching IPTV service providers and a result of searching IPTV services. At this time, the terminal entity 10 may use the IPTV service by executing an application related to the IPTV service, such as a web application.

In operation 120, the terminal entity 10 downloads at least one content item from the service provider 12 through the gateway entity 11. For example, when an IPTV service for downloading content, such as a video on demand (VoD) or content on demand (CoD) service is used, the terminal entity 10 sends a request to the gateway entity 11 to relay content of the service provider 12, and the gateway entity 11 transmits such a request to the service provider 12. In response to this request, the requested content is transmitted to the terminal entity 10 through the gateway entity 11.

The terminal entity 10 may simultaneously download a plurality of contents. At this time, the plurality of contents may be contents of different IPTV service providers. The kinds of the contents are not limited to any particular kind, and thus the contents may include all kinds of data related to IPTV services, such as moving picture data, music data and information data. Hereinafter, in this specification, content that is a subject of download will be referred to as a download item.

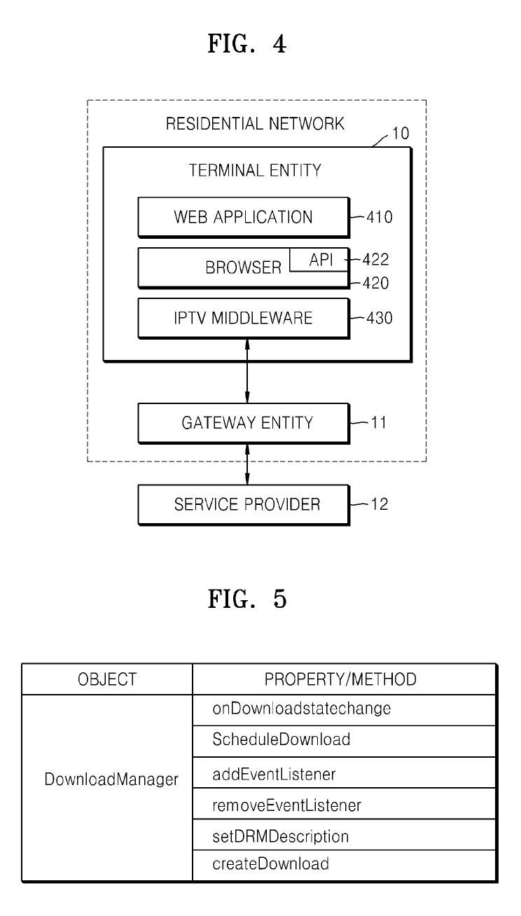

In operation 130, the terminal entity 10 presents an event related to at least one download item. The terminal entity 10 may present events related to all or some download items by using an application programmable interface (API) or a call-back function that is implemented in order to present the events related to all or some download items, which will be described in more detail with reference to FIG. 4.

According to the present embodiment, events related to some of a plurality of download items may be presented. That is, the events related to some of a plurality of contents being downloaded may be presented. In these cases, each of the events may be an event used to notify a user about information regarding a downloading status of each of the download items.

When a user presently executes an application for using an IPTV service of an IPTV service provider A, all download items that are currently received from IPTV service providers B and C in addition to a download item that is currently received from the IPTV service provider A may be presented to the user.

In order to present events related to the all download items to the user, information regarding download statuses of the all download items may be continuously checked. In addition, when a change in the download statuses occurs, the user may be notified about the change. That is, although the user is interested in download statuses of some of the download items only, the user is notified about the download statuses of the all download items. In this case, the program code of an application executing downloads becomes large and complicated, and resources of a terminal entity are incurred in order to notify the user about download statuses of download items in which the user is not interested.

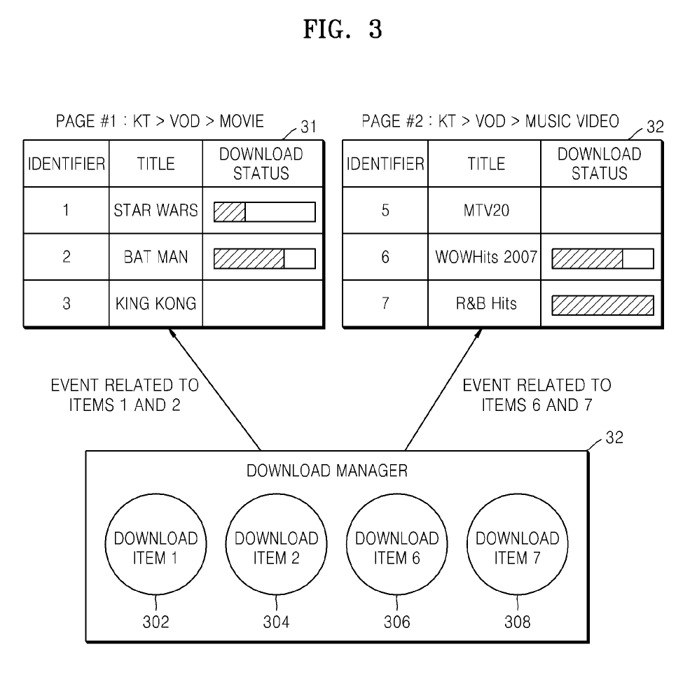

According to the present embodiment, by presenting only an event related to some download items from among all download items that are currently downloaded, a user may be notified about only an event related to some of download items in which the user is interested. Thus, unnecessary usage of resources of the terminal entity 10 may be prevented. This will be described with reference to FIGS. 2 and 3.

FIG. 2 is a diagram for explaining a method of presenting only an event related to some download items, according to an exemplary embodiment of the present invention.

Referring to FIGS. 1 and 2, in operation 110, the terminal entity 10 selects an IPTV service provider B 204 from among a plurality of IPTV service providers A, B and C 202, 204 and 206 which are searched through a screen 20 provided to search the IPTV service providers A, B and C 202, 204 and 206.

According to a result of selecting the IPTV service provider B 204, an application for using an IPTV service of the IPTV service provider B 204 is executed. The application may be a web application that is executed based on a web browser. A web page that is provided by the IPTV service provider B 204 is presented through the web application.

In operation 120, at least one download item of the IPTV service provider B 204 is downloaded.

In operation 130, the terminal entity 10 presents only an event related to download items 212 and 214 related to the IPTV service provider B 204 from among the at least one download item. A user is notified about only information regarding download statuses of the download items 212 and 214 related to the IPTV service provider B 204 through the web application that is currently executed.

The information regarding the download statuses may include at least one piece of information indicating that a download is completed, information indicating that a download is currently being performed, information indicating that a download is stopped, information indicating that a download failure has occurred, information indicating that download is not started yet. In addition, the information regarding the download statuses may include information regarding downloading degree (e.g., percent of download completion), or other types of status information.

FIG. 3 is a diagram for explaining a method of presenting only an event related to some download items, according to another exemplary embodiment of the present invention.

Referring to FIGS. 1 and 3, the terminal entity 10 presents only an event related to some download items, based on a web page which a user currently uses through a web application. For example, in operation 110, when the user selects “Korea Telecom (KT)” as an IPTV service provider, and uses a web page 31 regarding a movie category of a video one demand (VoD) service, the user is notified about only an event related to a download item 1 302 and a download item 2 304.

Although the terminal entity 10 currently downloads the download item 1 302, the download item 2 304, a download item 6 306 and a download item 7 308 from “KT” that is the IPTV service provider, the user is notified only about information regarding the download statuses of download item 1 302 and download item 2 304 which are related to a movie category of web page 31, which the user currently uses.

Similarly, when the terminal entity 10 uses a web page 32 regarding a music video category of a VoD service, the user is notified only about events related to download item 6 306 and download item 7 308 which are related to the music video category.

FIG. 4 is a diagram for explaining a downloading method according to an exemplary embodiment of the present invention.

The terminal entity 10 presents an event related to a download item by using an application programmable interface (API) or call-back function of a web browser, which will be described with reference to FIG. 4.

The terminal entity 10 may be an OITF entity according to open IPTV forum functional architecture. The terminal entity 10 accesses the IPTV service provided by the service provider 12 through gate entities of a residential network, that is, an application gateway function (AG) entity (not shown) and an IP multimedia subsystem (IMS) gateway (IG) entity 11. The terminal entity 10 may be a device that finally consumes the IPTV service, such as a TV.

An IPTV middleware 430 of the terminal entity 10 forms an IPTV network through the IG entity 11, and searches an IPTV service provider of a provider network and selects an IPTV service provider through the IPTV service provider search entity (not shown). Then, the IPTV middleware 430 of the terminal entity 10 searches for and accesses an IPTV communication service of the service provider selected through the IPTV service search entity (not shown).

A user of the terminal entity 10 uses an IPTV service by using a web application 410 that is executed based on a web browser 420. The web browser 420 provides various plug-in APIs or embedded APIs that are used for the user to access an object of the IPTV middleware 430 through the web application 410.

The web browser 420 may provide APIs 422 used to access an object of the IPTV middleware 430 managing a download service. For example, the web browser 420 may provide a plug-in API used to access an object managing at least one download item received from a plurality of IPTV service providers.

Plug-in APIs related to downloads may be APIs providing methods of starting, stopping and deleting a download. In addition, the web browser 420 may provide APIs 422 implementing a method of adding or deleting a download item whose event is to be presented in order to execute the download method of FIG. 1.

In order for an object “DownloadManager” of the IPTV middleware 430 managing the download service to notify the web application 410 about an event related to a download item, the download item whose event is to be presented may be determined. To achieve this, a web application calls a method for adding or deleting the download item to or from a list of download items whose events are to be presented, and registers or deletes the download item whose event is to be presented to or from the object “DownloadManager”.

The API for adding the download item is called to add a download item related to a service provider of an IPTV which a user currently uses or a download item related to a web page that is currently shown to a user to the list of download items whose events are to be presented.

For example, the web application 410 calls a method for adding a download item, adds download items 212 and 214 related to the IPTV service provider 2 204 to the list of download items whose events are to be presented, or adds the download items 302 and 304 related to the web page 31 of a movie category to the list of download items whose events are to be presented, as illustrated in FIG. 3.

When the IPTV service of the IPTV service provider 2 204 or the web page of the movie category is not used anymore, the web application 410 calls a method for deleting the download item, and deletes the registered download items 212, 214, 302 and 304 from the list of download items whose events are to be presented.

When all download items are added to the list of download items whose events are to be presented by using the method for adding download items, events related to all download items are presented through an application. On the other hand, when all download items 212, 214, 302 and 304 are deleted from the list of download items whose events are to be presented by using the method for deleting download items, the events related to all download items 212, 214, 302 and 304 are not presented.

According to another embodiment of the present invention, in the web application 410, “DownloadManager”, which is an object managing a download service, may notify the web application 410 about an event related to at least one download item by using a call-back function. When an event related to a download item included in a list of download items whose events are to be presented occurs, the event related to the download item may be presented using the call-back function notifying the web application 410 about the occurrence of the event. When a change in an event related to the download item, that is, a change in a download status occurs, a return value including information regarding the download status is returned to the web application 410.

Call-back with respect to all download items may be requested so as to present events related to all download items through the web application 410. Alternatively, call-back with respect to all download items may not be requested so as not to present events related to all download items.

Mapping may be performed with respect to the value returned to the web application 410 according to the method or the call-back function of the API, as follows.

TABLE 1

| Return value | Description |
|---|---|
| 0 | Download is completed |
| 1 | Download is currently performed |

One value from among return values which are mapped to information regarding download statuses is returned to the web application 410 by using the call-back function of “DownloadManager”. In addition, the web application 410 presents a download status according to the return value that is returned to the web application 410. For example, when “DownloadManager” returns a return value “3” related to a predetermined download item, the web application 410 notifies a user that a download failure of a corresponding download item has occurred.

The web application 410 may present reasons for a change in download status in addition to the return value. “DownloadManager” may return values indicating reasons for a change in download status, as follows.

TABLE 2

| Return value | Description |
|---|---|
| 0 | Local storage device is full |
| 1 | Download item is not capable of being |
| | downloaded |
| 2 | Download item is not valid anymore |

For example, when “DownloadManager” returns a value “0” related to a predetermined download item to the web application 410, the web application 410 notifies a user that a local storage device is not capable of downloading a corresponding download item since the local storage device is full.

FIG. 5 is a diagram for explaining a call-back function and a method, according to an exemplary embodiment of the present invention.

Referring to FIG. 5, “DownloadManager”, which is an object managing downloads, may support a call-back function “onDownloadStatuschange”, and methods “ScheduleDownload”, “addEventListener”, “removeEventListener”, “setDRMDescription” and “createDownload”.

When an event related to a download item included in a list of download items whose events are to be presented occurs, the call-back function “onDownloadStatuschange” is called to return information regarding a download status of the download item to the web application 410. By returning the return values of Table 1 and/or Table 2 to the web application 410, the web application 410 is notified about information regarding a change in a download status and reasons for the change.

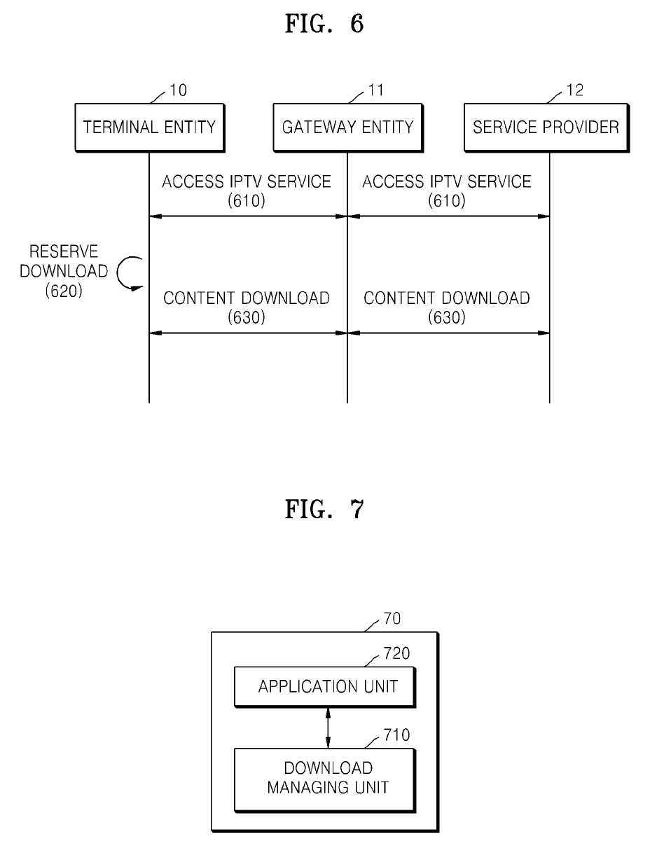

The method “ScheduleDownload” is an API supporting the web application 410 so as to reserve a download and to start the download at a predetermined time. The reservation of a download item by using the API will be described with reference to FIG. 6.

The method “addEventListener” is an API for adding a predetermined download item to the list of download items whose events are to be presented.

The method “removeEventListener” is an API for deleting a predetermined download item from the list of download items whose events are to be presented.

The method “setDRMDescription” is a method for setting digital rights management (DRM) information of the terminal entity 10. The web application 410 may set the DRM information of the terminal entity 10 in a DRM entity of a provider network by using the method “setDRMDescription”, and then may access DRM-adapted content according to the DRM information.

The method “createDownload” may simultaneously execute the methods “ScheduleDownLoad” and “setDRMDescription”. When a download item is DRM-adapted content, DRM information for accessing the DRM-adapted content may be set, and simultaneously a download may be reserved so as to receive a download item at a predetermined time.

FIG. 6 is a flowchart for explaining a downloading method according to another exemplary embodiment of the present invention.

Referring to FIG. 6, operation 610 corresponds to operation 110 of FIG. 1. In operation 610, the terminal entity 10 accesses an IPTV service through the gateway entity 11. That is, the terminal entity 10 accesses an IPTV service provider search entity (not shown) and searches for at least one IPTV service provider, and accesses the IPTV service search entity and searches for an IPTV service of the at least one IPTV service provider. Then, the terminal entity 10 may use the IPTV service by executing web applications.

In operation 620, the terminal entity 10 reserves downloads. The terminal entity 10 reserves downloads of content related to IPTV services of a plurality of IPTV service providers. The reservation of downloads may be performed using the methods that have been described with reference with reference to FIG. 5.

That is, the web application 410 executed in the terminal entity 10 calls the “ScheduleDownload” or “createDownload” of an API in order to reserve the download, and then an IPTV middleware object for managing downloads reserves the download.

In operation 630, the terminal entity 10 downloads at least one download item from the service provider 12 through the gateway entity 11. The terminal entity 10 downloads the download item of the service provider 12, wherein the download item of the service provider 12 is relayed by the gateway entity 11. The terminal entity 10 may simultaneously download a plurality of download items. At this time, the plurality of download items may be contents provided by different IPTV service providers. The kinds of the download items are not limited to any particular kind, and thus the download items may include all kinds of data related to IPTV services, such as moving picture data, music data and information data.

FIG. 7 is a block diagram of a downloading apparatus 70 according to an exemplary embodiment of the present invention.

Referring to FIG. 7, the downloading apparatus 70 includes a download managing unit 710 and an application unit 720.

The download managing unit 710 receives at least one download item through the gateway entity 11 relaying an IPTV service. The download managing unit 710 may manage download of the terminal entity 10, and may include an object which manages a download service of an IPTV middleware 420, as described with reference to FIG. 4.

The application unit 720 executes an application for using the IPTV service. The application may be a web application, or alternatively, may be a web application that varies according to a plurality of IPTV service providers. In addition, the web application may be an application executed based on a JAVA language.

The application that is currently executed by the application unit 720 may use the API illustrated in FIG. 5 in order to access an object managing a download service of the download managing unit 710. When the application calls a method for presenting an event related to a predetermined download item, the object managing the download service may notify the application about an event related to the download item.

Referring to FIGS. 5 and 7, when the application that is currently executed in the application unit 720 calls the method “addEventListener” for presenting an event related to the download item A, the object “DownloadManager” may notify the application unit 720 about an event related to the download item A.

The event related to the download item A may be presented using a call-back function.

Referring to FIGS. 5 and 7, the application that is currently executed in the application unit 720 requests a call-back on an event related to the download item B from the object “DownloadManager” of the download managing unit 710. Then, when the event related to the download item B occurs, the object “DownloadManager” notifies the application about the event by using the call-back function.

In addition, when the application of the application unit 720 calls a method for reserving a download, the object managing the download service of the download managing unit 710 reserves a download, and then performs the download according to a result of the reservation.

Referring to FIGS. 5 and 7, when the application that is currently executed in the application unit 720 calls the method “ScheduleDownload” or “createDownload” with regard to the download item A, the object “DownloadManager” of the download managing unit 710 reserves the download of the download item A, and then starts the download at a reserved time.

For example, the downloading apparatus 70 may include a bus coupled to each unit of the apparatuses of FIGS. 4 and 7, and at least one processor coupled to the bus. In addition, the downloading apparatus 70 may include a memory coupled to the bus and coupled to the at least one processor in order to store commands, receive messages, or generated messages, and to perform the commands.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A downloading method of a terminal entity, the downloading method comprising:
receiving at least one download item from an Internet protocol television (IPTV) provider through a gateway entity relaying an IPTV service; and
presenting an event related to the at least one download item through an application for using the IPTV service,
wherein the gateway entity is an entity relaying IPTV services of a plurality of IPTV service providers to the terminal entity.

2. The downloading method of claim 1, wherein the presenting comprises presenting only an event related to a download item related to one IPTV service provider from among the plurality of IPTV service providers.

3. The downloading method of claim 2, wherein the presenting comprises presenting only an event related to a download item related to the one IPTV service provider by using a method of an application programming interface (API) of a browser, and
wherein the browser provides an execution environment of the application.

4. The downloading method of claim 3, wherein the method of the API adds or deletes a download item to or from a list of download items whose events are to be presented.

5. The downloading method of claim 2, wherein the presenting comprises presenting only an event related to a download item related to the one IPTV service provider by using a call-back function, and
wherein the browser provides an execution environment of the application.

6. The downloading method of claim 5, wherein the call-back returns information regarding a download status.

7. The downloading method of claim 6, wherein the information regarding the download status comprises at least one piece of information from the group consisting of information indicating that download is completed, information indicating that download is currently being performed, information indicating that download is stopped, information indicating download failure, and information indicating that download is not started yet.

8. The downloading method of claim 1, wherein the presenting comprises presenting only an event related to a download item related to a web page that is currently provided to a user through the application.

9. A downloading apparatus of a terminal entity, the downloading apparatus comprising:
a download managing unit which receives at least one download item from an Internet protocol television (IPTV) provider through a gateway entity relaying an IPTV service; and
an application unit which presents an event related to the at least one download item through an application for using the IPTV service,
wherein the gateway entity is an entity which relays IPTV services of a plurality of IPTV service providers to the terminal entity.

10. The downloading apparatus of claim 9, wherein the application unit presents only an event related to a download item related to one IPTV service provider from among the plurality of IPTV service providers.

11. The downloading apparatus of claim 10, wherein the application unit presents only an event related to a download item related to the one IPTV service provider by using a method of an application programming interface (API) of a browser, and
wherein the browser provides an execution environment of the application.

12. The downloading apparatus of claim 11, wherein the method of the API adds or deletes a download item to or from a list of download items whose events are to be presented.

13. The downloading apparatus of claim 10, wherein the application unit presents only an event related to a download item related to the one IPTV service provider by using a call-back function, and
wherein the browser provides an execution environment of the application.

14. The downloading apparatus of claim 13, wherein the call-back function returns information regarding a download status.

15. The downloading apparatus of claim 14, wherein the information regarding the download status comprises at least one piece of information from the group consisting of information indicating that download is completed, information indicating that download is currently performed, information indicating that download is stopped, information indicating that download failure occurs, and information indicating that download is not started yet.

16. The downloading apparatus of claim 9, wherein the application unit presents only an event related to a download item related to a web page that is currently provided to a user through the application.

17. A computer readable recording medium having recorded thereon a program for executing the downloading method of claim 1.
